(19) United States
(12) Patent Application Publication
(10) Pub. No.: US 2015/0133291 A1
(43) Pub. Date: May 14, 2015

(54) Hydrothermal Stability of Oxides With Carbon Coatings

(71) Applicants: Abhaya Datye, Albuquerque, NM (US); Hien Pham, Albuquerque, NM (US)

(72) Inventors: Abhaya Datye, Albuquerque, NM (US); Hien Pham, Albuquerque, NM (US)

(73) Assignee: STC.UNM, Albuquerque, NM (US)

(21) Appl. No.: 14/400,232

(22) PCT Filed: Mar. 15, 2013
(86) PCT No.: PCT/US2013/032428

§ 371 Date: Nov. 10, 2014

Related U.S. Application Data
(60) Provisional application No. 61/644,165, filed on May 8, 2012.
(60) Provisional application No. 61/683,501, filed on Aug. 15, 2012.

(51) Int. Cl. B01J 37/08; B01J 37/02; B01J 23/44

(52) U.S. Cl. CPC B01J 37/084; B01J 23/44; B01J 37/0219
USPC 502/182; 502/439; 502/180

(57) ABSTRACT

Catalyst support materials that are coated with a thin carbon over-layer and methods for making the same are shown and described. In general, a supporting oxide material, which may or may not have a catalytic material already deposited on the surface, is coated with a thin carbon layer.

### CROSS-REFERENCE TO RELATED APPLICATIONS

The following application claims benefit of U.S. Provisional Application Nos. 61/644,165, filed May 8, 2012 and 61/683,501, filed Aug. 15, 2012, each of which is hereby incorporated by reference in its entirety.

### STATEMENT REGARDING GOVERNMENT SPONSORED RESEARCH

This invention was made with Government support under Grant No. EEC0813570 awarded by the National Science Foundation (NSF). The U.S. Government has certain rights in this invention.

### BACKGROUND

Oxide supports such as silica or alumina are important components of heterogeneous catalysts used in petroleum refining, in automotive exhaust catalytic converters, and in the pharmaceutical industry, to name just a few examples. There is a need to diversify the sources of carbon for the manufacture of chemicals and fuels, so we see at present a worldwide interest in conversion of biomass based reactants. Water constitutes a significant fraction of biomass, so the most efficient routes for processing biomass based reactants involve processing in the aqueous phase. Accordingly, catalysts for the production of biorenewable chemicals frequently operate under aqueous phase conditions, generally at temperatures above 473 K. However, conventional oxide supports designed for gas-phase reactions are not suitable for aqueous-phase reactions at these elevated temperatures as they are susceptible to degradation in the aqueous phase at elevated temperatures. For example, alumina undergoes a phase change from γ-Al₂O₃ to boehmite at 473 K with a consequent loss of surface area. Likewise, mesoporous silica SBA-15 suffers from collapse of the well-ordered mesoporous structure when heated to 473 K in liquid water, resulting in loss of its surface area and structural integrity. Accordingly there is a need for oxide supports and catalysts that are able to maintain structural integrity and catalytic activity under harsh treatment conditions.

### SUMMARY

According to various embodiments the present disclosure provides catalyst support materials that are coated with a thin carbon over-layer and methods for making the same. In general, a supporting oxide material, which may or may not have a catalytic material already deposited on the surface, is coated with a thin carbon layer. The supporting material and carbon layer are then subjected to partial pyrolysis, resulting in a stable material that is able to withstand high temperatures under aqueous phase conditions. After partial pyrolysis, the catalyst support may or may not have a catalyst material deposited on the thin carbon layer. According to some embodiments the support may be reusable, allowing for the repeated deposition and removal of the thin carbon layer.

### BRIEF DESCRIPTION OF THE DRAWINGS

FIG. 1 is a flowchart showing a method for forming a catalyst support according to a first embodiment of the present disclosure.

FIG. 2 is a flowchart showing a method for forming a catalyst support according to another embodiment of the present disclosure.

FIG. 3 is a flowchart showing a method for forming a catalyst support according to a further embodiment of the present disclosure.

FIG. 4 is a flowchart showing a method for forming a catalyst support according to a still further embodiment of the present disclosure.

FIG. 5 is a schematic illustration of a method or reusing and reapplying the supporting material and thin carbon coating according to an embodiment of the present disclosure.

FIG. 6 is a schematic illustration of a method or reusing and reapplying the supporting material and thin carbon coating according to an embodiment of the present disclosure.

FIG. 7 is an HRTEM image of calcined SBA-15.

FIG. 8 is an elemental carbon map of SBA-15.

FIG. 9 is an HRTEM image of 10 wt % carbon-SBA-15.

FIG. 10 is an elemental carbon map of 10 wt % carbon-SBA-15.

FIG. 11 is an N₂ sorption isotherm obtained from calcined SBA-15 (circles) and 10 wt % carbon-SBA-15 (squares).

FIG. 12 shows the pore size distribution for calcined SBA-15 (circles) and 10 wt % carbon-SBA-15 (squares).

FIG. 13 is a STEM image of calcined SBA-15, the inset shows well-ordered pores.

FIG. 14 is a STEM image of calcined SBA-15 after treatment in liquid water at 473 K for 12 hours.

FIG. 15 is a STEM image of 10 wt % carbon-SBA-15, the inset shows well-ordered pores.

FIG. 16 is a STEM image of 10 wt % carbon-SBA-15 after treatment in liquid water at 473 K for 12 hours.

FIG. 17 is an HAADF-STEM image of 25 wt % carbon-SBA-15.

FIG. 18 is an HAADF-STEM image of 25 wt % carbon-SBA-15 after treatment in liquid water at 473 K for 12 hours.

FIG. 19 is a STEM image of silica gel.

FIG. 20 is a STEM image of silica gel after treatment in liquid water at 473 K for 12 hours.

FIG. 21 is a STEM image of 10 wt % carbon-silica gel.

FIG. 22 is a STEM image of 10 wt % carbon-silica gel after treatment in liquid water at 473 K for 12 hours.

FIG. 23 is a STEM image of fumed alumina.

FIG. 24 is a STEM image of fumed alumina after treatment in liquid water at 473 K for 12 hours.

FIG. 25 is a STEM image of 10 wt % carbon-alumina.

FIG. 26 is a STEM image of 10 wt % carbon-alumina after treatment in liquid water at 473 K for 12 hours.

FIG. 27 is a quantitative ¹³C NMR spectra of all carbon atoms (thick line), and of nonprotonated carbon atoms and CH₃ groups (thin line) in ¹³C-enriched carbon-SBA-15, ssb=spinning sideband (14 kHz MAS).

FIG. 28 is a structural model reproducing the experimental spectra.

FIG. 29 is an HRSEM image of Stöber spheres.

FIG. 30 is an HRSEM image of Stöber spheres after treatment in liquid water at 473 K for 12 hr

FIG. 31 is an HRSEM image of 10 wt % carbon-Stober spheres.

FIG. 32 is an HRSEM image of 10 wt % carbon-Stober spheres after treatment in liquid water at 473 K for 12 hr

FIG. 33 is FTIR spectra of calcined a) SBA-15, b) 10 wt % carbon-SBA-15, and after rehydration at room temperature, (c) 10 wt % carbon-SBA-15 and (d) SBA-15.

FIG. 34 is a graph showing XRD patterns of fumed alumina (a) and 10 wt % carbon-alumina (b), and of 10 wt % carbon-alumina (c) and fumed alumina (d) after treatment in liquid water at 473 K for 12 h.

FIG. 35 is HAADF-STEM images of 1 to 1.5 nm Pd nanoparticles (0.5 wt %) supported on silica gel (a) and on 10 wt % carbon-silica gel (b).

FIG. 36 is a graph showing selective hydrogenation of a mixture of acetylene/ethylene (1:70) on 0.5 wt % Pd on alumina (open circles) and on 10 wt % carbon-alumina (closed circles); 0.5 wt % Pd on silica gel (open squares) and on 10 wt % carbon-silica gel (closed squares).

FIG. 37 is a TGA of sucrose-containing SBA-15 performed under N₂ flow from 25-800° C. (5 K min⁻¹).

FIG. 38 is an image of 0.5 wt % Pd on silica.

FIG. 39 is a close-up image of the 0.5 wt % Pd on silica of FIG. 38.

FIG. 40 shows the 0.5 wt % Pd on silica after treatment in liquid water at 473 K for 12 hr.

FIG. 41 is a close-up image of the 0.5 wt % Pd on silica of FIG. 40.

FIG. 42 is an image of 0.5 wt % Pd on carbon-silica.

FIG. 43 is a close-up image of the 0.5 wt % Pd on carbon-silica of FIG. 42.

FIG. 44 shows the 0.5 wt % Pd on carbon-silica after treatment in liquid water at 473 K for 12 hr.

FIG. 45 is a close-up image of the 0.5 wt % Pd on carbon-silica of FIG. 44.

FIG. 46 is an image of Carbon on 0.5 wt % Pd/silica.

FIG. 47 is a close-up image of the Carbon on 0.5 wt % Pd/silica of FIG. 46.

FIG. 48 shows the Carbon on 0.5 wt % Pd/silica after treatment in liquid water at 473 K for 12 hr.

FIG. 49 is a close-up image of the Carbon on 0.5 wt % Pd/silica of FIG. 48.

### DETAILED DESCRIPTION

According to an embodiment the present disclosure provides catalyst support materials that are coated with a thin carbon over-layer and methods for making the same. The thin carbon over-layer results in a more stable material and, surprisingly, when combined with the carbon coated supports of the present disclosure, some catalytic materials demonstrate higher catalytic activity than the same catalysts deposited on uncoated supports.

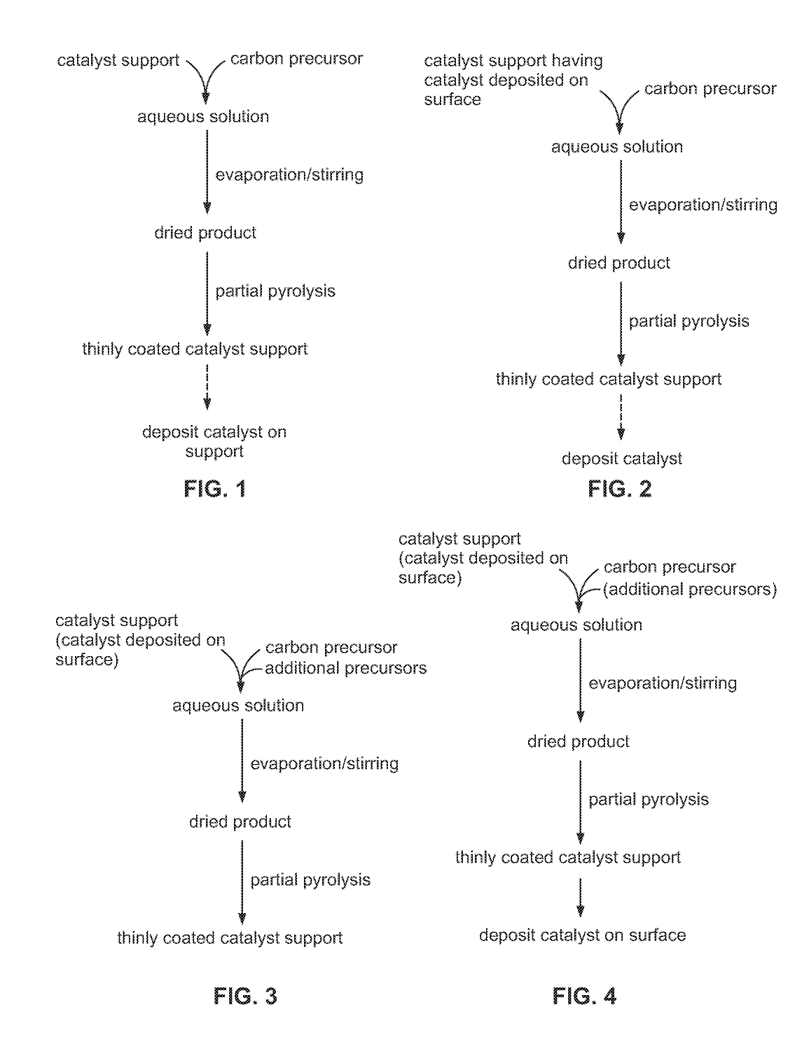

FIG. 1 is a flow chart showing a general embodiment of the presently described method. As shown, a catalyst support material, or precursor therefore, is exposed to an aqueous solution containing a carbon precursor. The aqueous solution is then allowed to evaporate, typically while stiffing, until a dry product is produced. The dry product is then partially pyrolyzed to produce a catalyst support with a thin carbon over-layer. As shown, if desired the active phase can then be deposited on this carbon-coated surface just like on any carbon support used to make catalysts. However, as explained below, this surface carbon is an active form of carbon, with functional groups and anchoring sites created uniquely through a combination of using a suitable precursor and the appropriate pyrolysis conditions.

The catalyst support may be any suitable material including, for example, oxide supports such as silica, SBA-15, alumina, niobia, and ceria. The catalyst support may be exposed to the aqueous solution in a precursor form, and thus synthesized in vitro, or already synthesized. Furthermore, the catalyst support may be a fully formed (granulated) commercially available support or in powder form, for example Sigma-Aldrich Davisil silica gel. Alternatively, the support may be a mixed-oxide such as aluminosilicate, or a composite such as a metal oxide on carbon.

Furthermore, and importantly, the above-described method is amenable to coating catalyst support material of any size or structure and having or incorporating any shape. Those of skill in the art will know that one of the primary functions of many catalyst supports is to provide a high surface area. One way in which this is achieved is by preparing catalyst supports comprised of nanosized primary particles. Metal (or other) catalysts are frequently deposited on such oxides because the nanosized primary particles constitute the porous structure of the support, thereby creating a catalyst support with a high surface area. Another class of catalyst support has an ordered structure with a one-, two- or three-dimensional arrangement of pores. These pores can have a cylindrical shape or a complex internal geometry and interconnections. In these materials, the surface area accessible to the catalytic material includes the internal surfaces, which are concave. The methods describe herein easily coat both convex and concave surfaces, as well as regular, and irregular surfaces, and combinations thereof.

According to some embodiments, the carbon precursor may be sucrose. Other suitable carbon precursors may be glucose, fructose, maltose, lactose, starch, and cellulose. In general, the concentration of sucrose (or other carbon precursor) in the aqueous solution determines the thickness of the resulting carbon layer. According to various embodiments, it is desirable to have a coating that is thick enough to impart stability to the coated support material, but not so thick that it impedes the support material's ability to enhance the performance of the attached catalytic material. In general, we have found that aqueous solutions of between 5 and 30 wt % sucrose will produce coatings with desirable attributes. Accordingly, an aqueous sucrose solution according to the present disclosure may be between 5 and 30 wt %, 5 and 25 wt %, 7 and 20 wt %, 10 and 20 wt %, or any other suitable wt %. According to some specific embodiments, we have found that 10 wt % and 25 wt % sucrose solutions resulted in catalysts that, when compared to the equivalent uncoated supports, have increased stability and, in some cases, increased catalytic activity.

As stated above, the aqueous solution containing the catalyst support material and carbon precursor is allowed to evaporate, typically under stirring to prevent settling. Alternatively, the solution may be shaken, turned, rotated, or otherwise disturbed so as to prevent settling. This may be performed at room temperature or at temperatures up to 80° C. to reduce the evaporation process time.

The temperature and length of time at which the dried material is subjected to pyrolysis will largely depend on the actual material being used. For the purpose of the present disclosure, complete pyrolysis is considered to have been achieved when 100% of the carbon materials is graphitic carbon (i.e., above 800° C.) with no remaining functional groups. Partial pyrolysis is achieved when at least 25% of the carbon materials contains functional groups (i.e., 400° C.). Accordingly, the methods of the present disclosure use partial pyrolysis to ensure that the catalyst material coated with carbon retains some functional groups (partially hydrophilic) needed for anchoring of metal nanoparticles or other active phases. In turn, graphitic carbon is inert and hydrophobic and typically needs to be surface-functionalized before anchoring metal nanoparticles or other active phases. According to some specific embodiments, pyrolysis may be performed for between 1 and 8 hours, between 1 and 6 hours, between 1 and 4 hours, or around 2 hours at a temperature of between 200° C. and 600° C., between 300° C. and 500° C., between 350° C. and 450° C., or around 400° C.

Turning now to FIG. 2, according to a further embodiment, catalytic materials may be deposited on the support materials prior to coating. Examples of material that may be deposited on the support material include platinum and platinum group metals (PGM) and alloys thereof, oxides, carbides, nitrides, functional materials, and other transition metals. The catalytic material may, for example, take the form of nanoparticles. The particles may be monodisperse or polydisperse. In some cases the carbon layer may coat the particles entirely, in other cases a portion of the particles may be uncoated.

FIG. 3 provides yet another embodiment, wherein additional precursors such as catalyst precursors like palladium nitrate or niobium oxalate, are added to the aqueous solution. Instead of, or in addition to, depositing the catalyst on the coated support material, the catalyst precursor is added to the aqueous solution containing the sucrose and support material. Partial pyrolysis results in both the formation of the carbon layer and the transformation of the catalyst precursors to form the active catalyst. In some cases the carbon layer may coat the active phase entirely (referred to herein as an “overlayer”), in other cases a portion of the active phase may be uncoated. This coating procedure improves the stability of the active phase.

FIG. 4 provides still another embodiment showing the deposition of catalyst or other material on the surface of the coated catalyst support. If a catalyst was deposited prior to coating, the material deposited after coating may be the same or a different material from the catalyst that was previously deposited. Examples of material that may be embedded in or deposited on the carbon layer include palladium and palladium group metals and alloys thereof, oxides, carbides, functional materials, and other transition metals. The catalytic material may, for example, take the form of particles. The particles may be monodisperse or polydisperse.

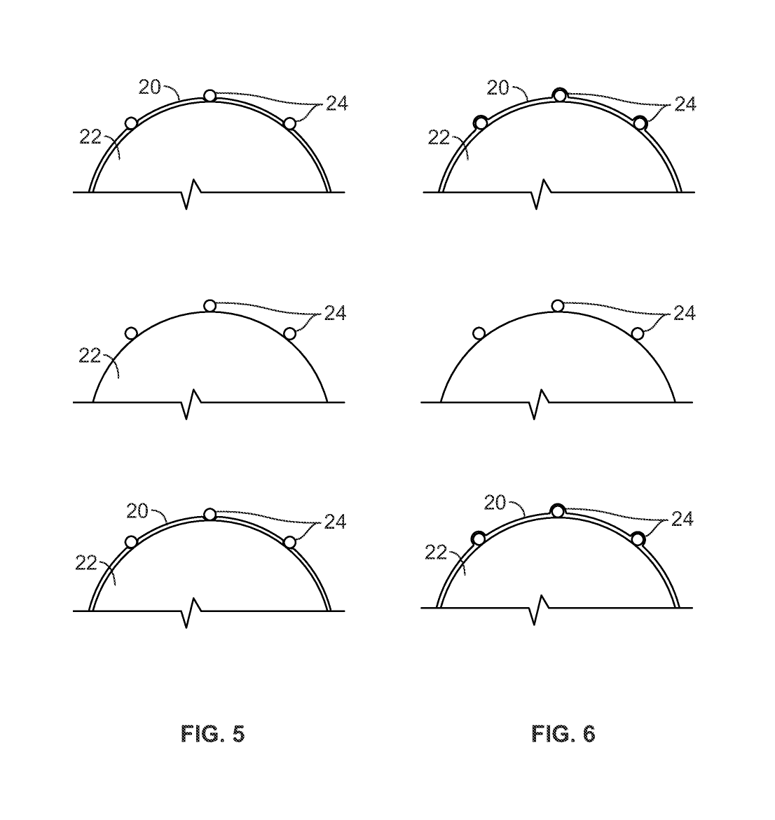

According to some embodiments the support may be reusable, allowing for the repeated deposition and removal of the thin carbon layer. Accordingly, as shown in FIGS. 5 and 6, the present disclosure provides a mechanism for reusing the oxide support. As shown in FIG. 5, oxide support 22 includes a thin carbon layer 20 on which are deposited catalyst particles 24. If desired, the support can be subjected to heat treatment conditions (for example through oxidation) such that the carbon layers are burned off of the support. A new thin carbon layer 20 can then be reapplied to the support. Alternatively, as shown in FIG. 6, wherein the thin carbon layer was initially an overlayer deposited over the catalyst layers, the overlayer can be removed via heat treatment and then reapplied. It should be noted that whether the carbon layer ends up forming over (as in FIG. 6) or around (as in FIG. 5) the catalyst particles may depend on the thickness of the carbon layer applied and the size of the catalyst particles. Accordingly, by controlling the wt % of carbon loading, one can determine the ultimate formation of the carbon layer in relationship to the catalyst particles or any other material incorporated into the support. A reusable support material as described above may be desirable, for example, in situations where the catalyst is poisoned and needs to be regenerated in an oxidizing environment which would cause the carbon coating to be lost and it is desirable to regenerate it in a quick and efficient matter.

It will be understood that the terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

All patents and publications referenced below and/or mentioned herein are indicative of the levels of skill of those skilled in the art to which the invention pertains, and each such referenced patent or publication is hereby incorporated by reference to the same extent as if it had been incorporated by reference in its entirety individually or set forth herein in its entirety. Applicants reserve the right to physically incorporate into this specification any and all materials and information from any such cited patents or publications.

### Examples

### Example 1

### Preparation and Characterization of Carbon Coated SBA-15, Silica, and Alumina

To prepare mesoporous silica SBA-15, Pluronic P123 surfactant (4.0 g) was dissolved in deionized water (30 g) while stirring at 308 K. Once dissolved, 2M HCl (120 g) and tetraethyl orthosilicate (TEOS; 8.6 g) were added to the solution. The solution was then transferred to a Nalgene bottle and placed in a water bath at 308 K without stiffing for 20 h. The solid product was filtered, washed with deionized water, and air-dried at room temperature. The dried product was calcined in air at 773 K (5 K min⁻¹ ramp) for 12 h to remove the P123 template.

To coat the surface of oxides with 10 wt % carbon, an aqueous solution of sucrose (¹³C-glucose for NMR measurements) was added to SBA-15, silica gel, or fumed alumina. The mixture was stirred at room temperature overnight until the water evaporated. The dried product was collected and partially pyrolyzed under flowing UHP N₂ gas at 673 K (5 K min⁻¹ ramp) for 2 h.

Palladium acetate was completely dissolved in methanol by sonication for 10 min, and the solution was added to the uncoated or 10 wt % carbon-coated oxides to obtain a Pd loading of 0.5 wt %. A Buchi rotary evaporator was used to gently remove methanol from the sample at 313 K, and the dried product was collected. Selective acetylene hydrogenation to ethylene was performed with a reactant mixture (0.5% acetylene, 35% ethylene, balance N₂; 70 cm³ (STP) min⁻¹), hydrogen (3.5 cm³ (STP) min⁻¹) and nitrogen (75 cm³ (STP) min⁻¹), with a hydrogen/acetylene ratio of 7:1. Reactivity measurements for the samples (20 mg) were carried out at temperatures from 308 to 388 K, and the gas effluents were analyzed by GC (Varian CP-3800).

Samples were dispersed in ethanol and mounted on holey carbon grids for examination in a JEOL 2010F 200 kV transmission electron microscope. Images were recorded both in bright field (BF) and high angle annular dark field (HAADF) modes. Elemental carbon maps were acquired using energy-filtered transmission electron microscopy (EFTEM) with an exposure time of 8 s for the SBA-15-based samples. Surface area was measured using N₂ adsorption at 77 K in a Micromeritics Gemini 2360 multipoint BET analyzer. N₂ sorption isotherms and pore-size distributions were measured at 77 K in a Quantachrome Autosorb-1 analyzer. Infrared spectra of samples were recorded on a Nicolet 7600 FTIR analyzer equipped with an attenuated total reflectance (ATR) attachment. The spectra were acquired between 400-4000 cm⁻¹ at 4 cm⁻¹ resolution and 128 scans. ¹³C NMR spectroscopy was performed at 100 MHz on ¹³C-enriched samples washed with water to remove trapped low-molar mass species, using a Bruker DSX400 spectrometer, magic-angle spinning at 14 kHz, and highpower ¹H decoupling. Quantitative ¹³C NMR spectra were measured using direct polarization (DP) and a Hahn echo, with recycle delays of 30 s (>5 T₁), and spectra of nonprotonated carbon atoms (and mobile segments) were obtained after recoupled ¹³C—¹H dipolar dephasing. X-ray powder diffraction (XRD) was performed using a Scintag Pad V diffractometer (Cu Ka radiation) with DataScan 4 software (MDI, Inc.)

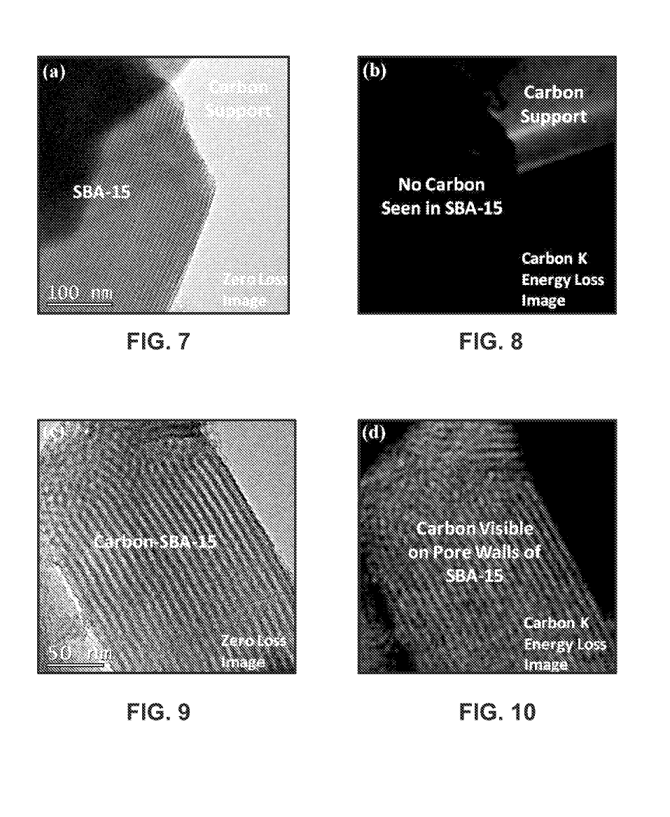

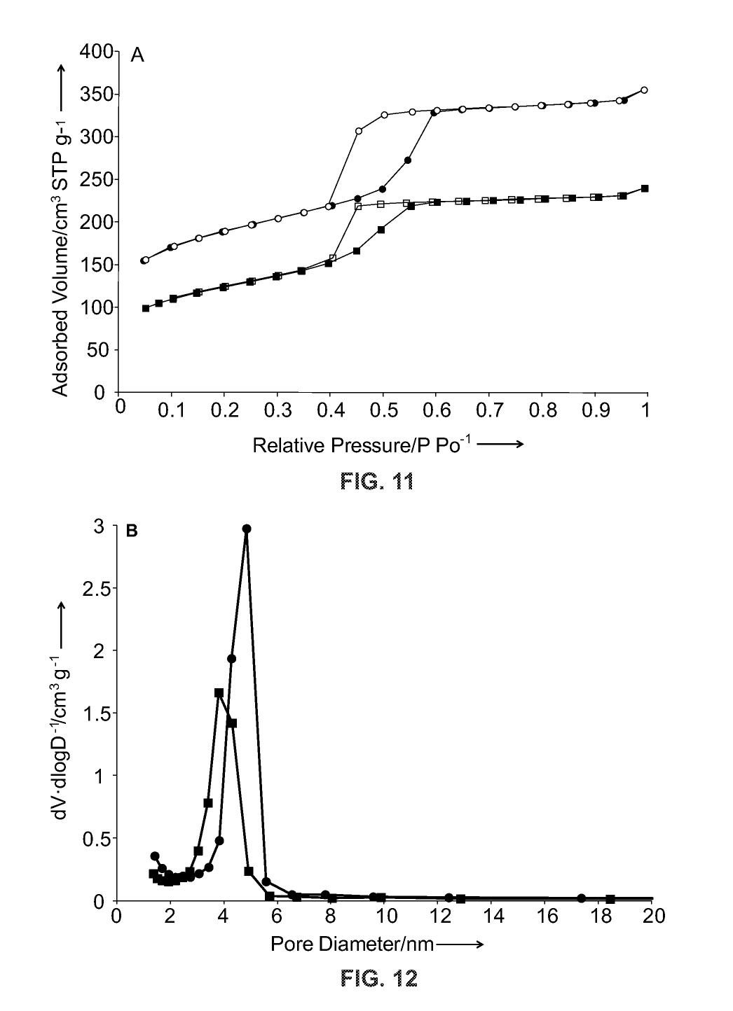

To confirm the presence of carbon on the pore walls of SBA-15, we acquired elemental carbon maps through energy-filtered transmission electron microscopy (EFTEM). Elemental-carbon maps of the SBA-15-based samples are shown in FIGS. 7-10, in which lit up regions indicate the location of carbon in the EFTEM image at the carbon K edge. The uncoated SBA-15 particle is dark in the map (FIG. 8), indicating that carbon is not present. For reference, the underlying carbon support film is visible in the EFTEM map. The HRTEM image of carbon-coated SBA-15 (FIG. 9) is similar to that of uncoated SBA-15 (FIG. 7), because carbon does not produce any additional contrast in this image. However, the EFTEM image of coated SBA-15 (FIG. 10) shows bright regions indicating the location of the carbon within the pores, and the dark regions within SBA-15 correspond to the silica walls. These images confirm that it is possible to coat the internal surfaces of the SBA-15 mesoporous silica with carbon. From the EFTEM image of coated SBA-15, it might appear that carbon has filled the pores of SBA-15. However, N₂ sorption isotherms obtained from the coated samples are very similar to the uncoated SBA-15, indicating a narrow pore-size distribution (FIGS. 11 and 12). Because of the coating, the pore diameter decreases from 4.8 nm in SBA-15 to 3.8 nm for carbon-coated SBA-15 (see Table 1, below). The major difference is the loss of microporosity and a decrease in total pore volume as a result of a narrowing of the pores. These are the major factors that cause a decrease in the total BET surface area of the carbon-coated sample.

TABLE I
Structural Properties for calcined SBA-15 and carbon-SBA-15

| | S_{BET} | S_{Microp} | V_{P} | V_{P-Microp} | D_{P} |
|---|---|---|---|---|---|
| Sample | m²g⁻¹ | (m²g⁻¹) | (cm³g⁻¹ | (cm³g⁻¹) | (nm) |
| SBA-15 | 740 | 241 | 0.46 | 0.12 | 4.8 |
| 10 wt % Carbon-SBA-15 | 528 | 109 | 0.33 | 0.056 | 3.8 |
| 25 wt % Carbon-SBA-15 | 465 | 91 | 0.19 | 0.049 | 3.1 |

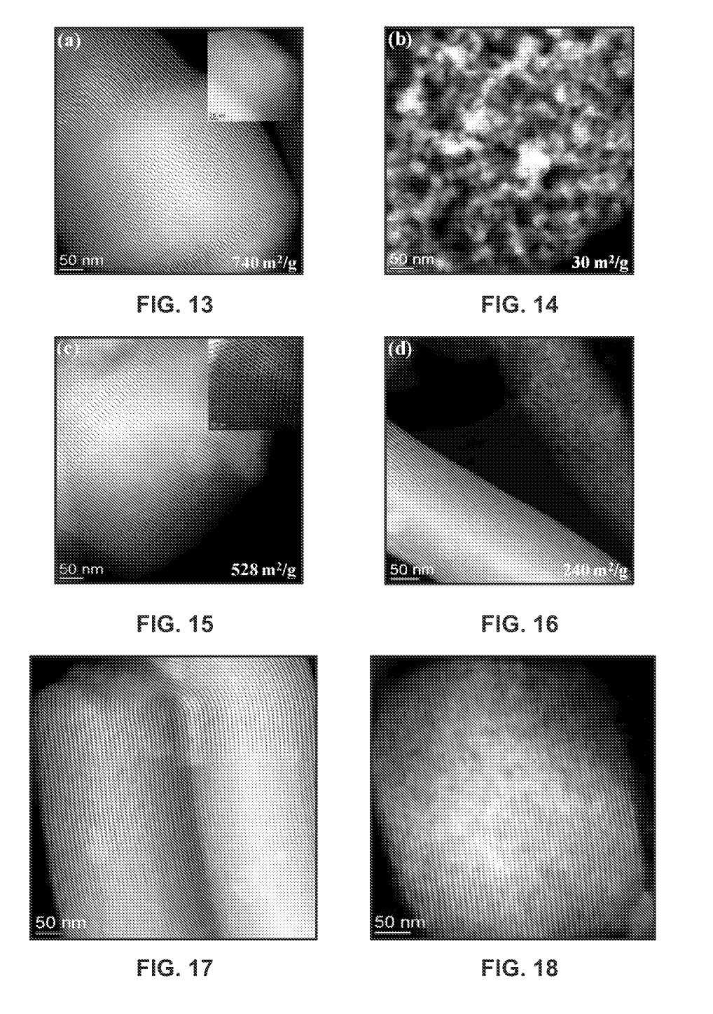

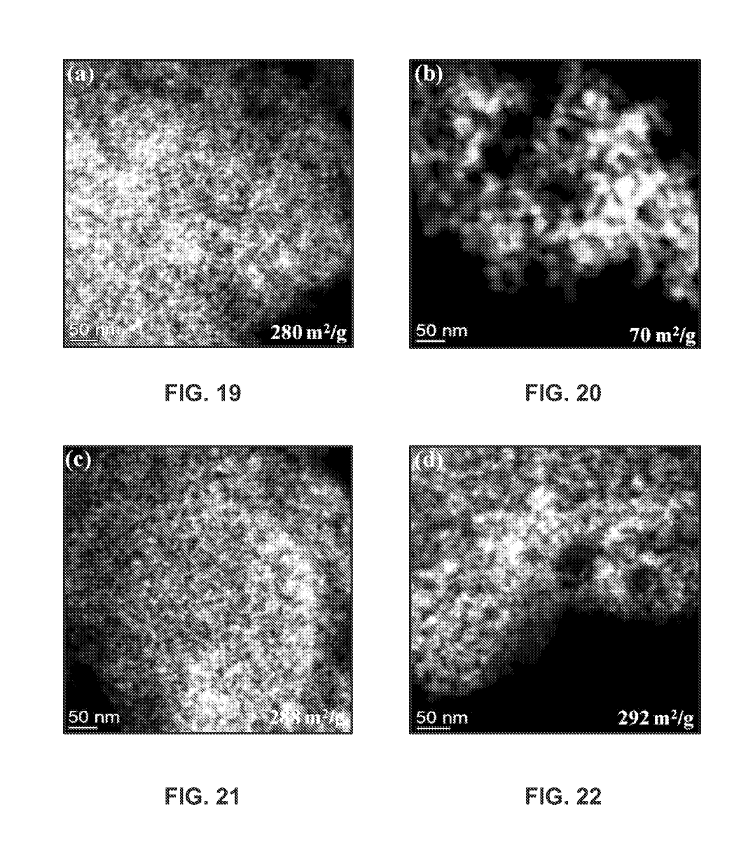

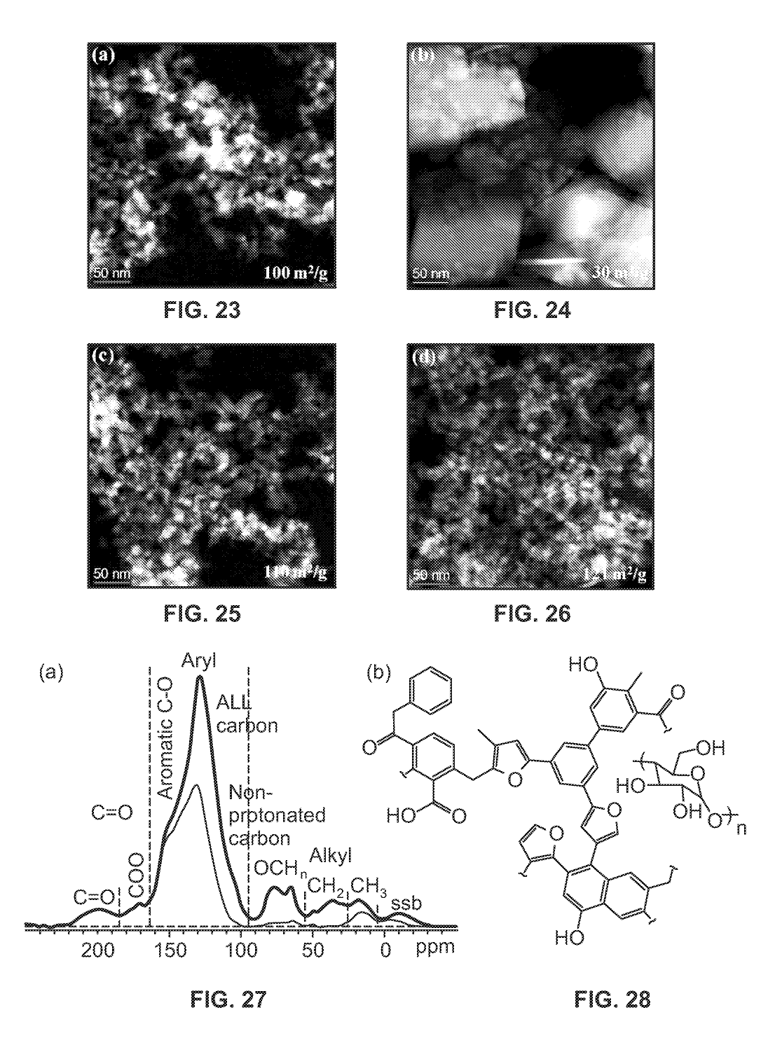

HAADF-STEM images of the SBA-15-based samples (FIGS. 13-16) show the retained hexagonal arrangement of pores (inset) after coating the pore walls of SBA-15 (FIG. 13) with carbon (FIG. 15). After treatment in liquid water at 473 K for 12 h, uncoated SBA-15 loses 96% of its surface area as a result of a complete collapse of the ordered mesopores, and loss of its structural integrity (FIG. 14). In contrast, hydrothermal stability is significantly improved after coating SBA-15 with carbon, with a surface-area loss of only 55% and a partially retained ordered mesoporous structure (FIGS. 16). If we increase the carbon loadings (e.g., 25 wt %), we can further retain the well ordered structure of SBA-15 and minimize the loss of surface area after hydrothermal treatment (see FIGS. 17 and 18). For the silica gel based samples (FIGS. 19-22), uncoated silica gel (FIG. 19) loses 75% of its surface area after hydrothermal treatment because of grain growth and sintering (FIG. 20), whereas carbon coated silica gel (FIG. 21) neither loses surface area nor its structural integrity after hydrothermal treatment (FIG. 22). For the alumina based samples (FIGS. 23-26), uncoated alumina (FIG. 23) loses 70% of its surface area after hydrothermal treatment (FIG. 24), whereas both the morphology and surface area of carbon-coated alumina (FIG. 25) are retained after hydrothermal treatment (FIG. 26).

The chemical composition of the carbon layer was probed by solid-state NMR spectroscopy. FIG. 27 shows the ¹³C NMR spectrum of carbon-SBA-15 produced using ¹³C enriched glucose, with the corresponding spectrum of the nonprotonated carbon atoms (and mobile segments) superimposed. The spectra are dominated by signals of aromatic carbon atoms between 100 and 160 ppm (75% aromaticity). Nevertheless, CH₃ (3.5%), alkyl CH/CH₂ (5%), OCHₙ (10%), COOH (3.5%), and C═O (3.5%) are also observed; a ¹³C—¹³C correlation NMR spectrum shows that the C═O and alkyl CHₙ groups are attached to the aromatic rings, while many of the OCHₙ carbon atoms are not. From the fractions of aromatic C—O (14%) and C—H (32%), and C═O, COO, and alkyl-C bonded to aromatic rings, one finds that aromatic carbon atoms that are bonded only to other aromatic carbon atoms, as found in polycondensed rings, account for approximately ⅕ of all signals of carbon atoms. Aromatic H—C—O intensity indicates that more than 6% of carbon atoms are part of furan rings. A structural model reproducing the measured spectra is shown in FIG. 28.

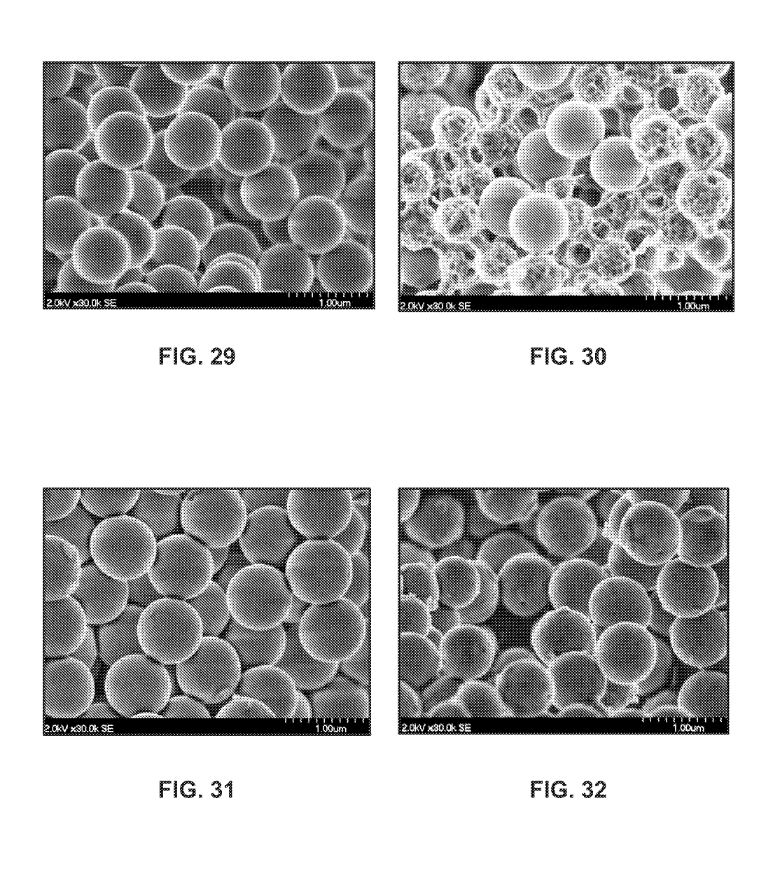

In addition to depositing a thin film of carbon on a concave surface, such as on the pore walls of SBA-15, we can improve the hydrothermal stability of oxides that have a convex surface, such as Stöber spheres, a nonporous silica with a BET surface area of 10 m²g⁻¹ (see FIGS. 29-32). After hydrothermal treatment, uncoated Stöber spheres show pronounced neck formation as a result of sintering of the spheres, as well as formation of large pores in the spheres. In contrast, hydrothermal stability is improved after coating Stöber spheres with carbon, with retention of the individual coated spheres and no pronounced sintering or formation of large pores after hydrothermal treatment. Furthermore, there is no delamination and formation of defects, which are generally more pronounced when thin films are deposited on convex surfaces rather than on concave ones.

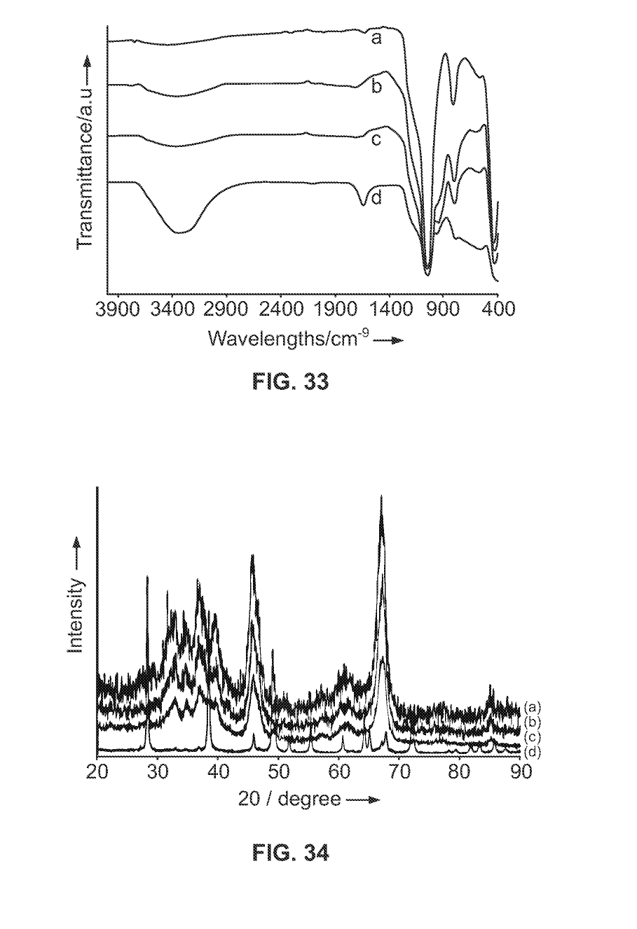

The FTIR spectra of the SBA-15-based samples (FIG. 33) show a broad absorption band at around 3200-3600 cm⁻¹ assigned to the O—H stretching vibration, and an absorption band at around 1640 cm⁻¹ assigned to the bending vibrations of molecular water. Both the absorption bands at around 3200-3600 cm⁻¹ and at around 1640 cm⁻¹ are initially small for SBA-15, which is expected because FTIR was performed on SBA-15 just after calcination to remove the surfactant, thus minimizing exposure of SBA-15 to moisture. These two absorption bands slightly increased for carbon coated SBA-15 after SBA-15 was mixed with the aqueous sucrose solution followed by carbonization. We then rehydrated each sample by resuspending it in water at room temperature overnight in order to determine the extent of readsorbed water on the pore walls of SBA-15. SBA-15 shows a significant increase in the absorption bands at around 3200-3600 cm⁻¹ and at around 1640 cm⁻¹ after rehydration, which indicates that water has re-adsorbed on the pore walls of SBA-15. In contrast, re-adsorption occurs to a much lesser extent for carbon-coated SBA-15. The results suggest that SBA-15 changes from a hydrophilic to a more hydrophobic state after coating the pore walls with 10 wt % carbon. The FTIR results are in agreement with improved hydrothermal stability for carbon-coated SBA-15. The surface of the uncoated silica samples used in this study consists of siloxane bridges and silanol groups. When silica is exposed to water at elevated temperatures, silicate hydrolysis occurs. The hydrolytic cleavage of the siloxane bonds leads to a dissolution and reprecipitation of silica, resulting in loss of both high surface area and structural integrity. By coating the surface of silica with carbon, we make the surface resistant to hydrolytic attack. With increased carbon loading, we are able to further improve the stability of the SBA-15 sample. FIG. 34 shows the XRD patterns of the alumina-based samples. Before hydrothermal treatment, the patterns for both uncoated (a) and carbon-coated alumina (b) are characteristic of the γ-Al₂O₃ phase. After hydrothermal treatment, the XRD pattern for uncoated alumina is characteristic of boehmite (d). The transformation from γ-Al₂O₃ to boehmite is due to hydration of alumina when it is subjected to liquid water at 473 K for several hours. In contrast, carbon coated alumina remains as γ-Al₂O₃ after hydrothermal treatment (c). This shows that we are able to modify the surface of alumina with carbon before subjecting it to hydrothermal conditions, thereby achieving improved stability. The extent of carbon coating, and the carbon loading, can be varied to achieve different degrees of surface modification of the γ-Al₂O₃ surface.

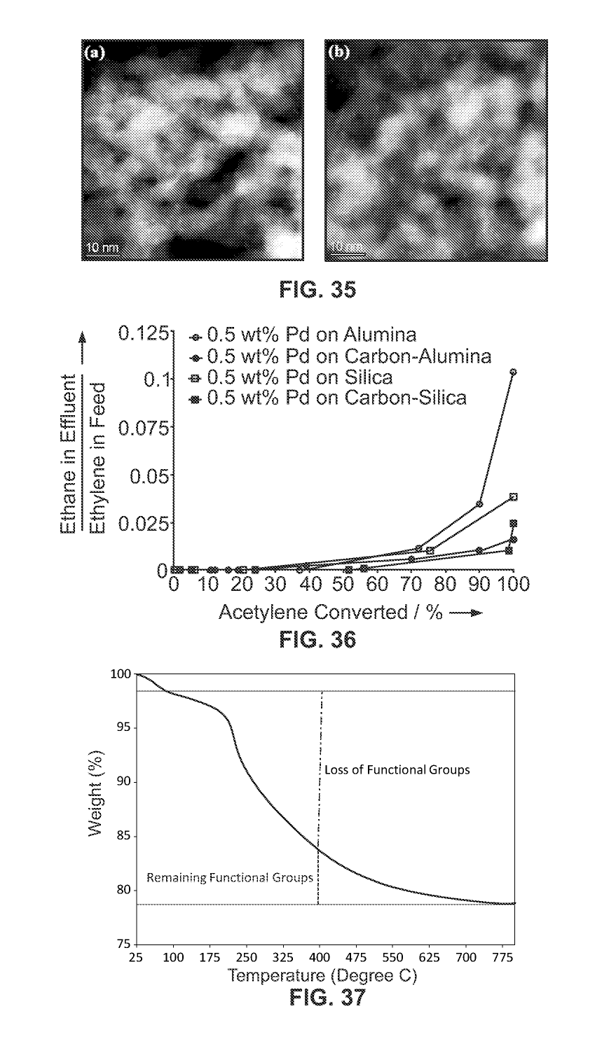

We have also explored the catalytic performance of carbon-coated oxides. The reaction we chose was the selective hydrogenation of acetylene in the presence of excess ethylene. In previous work, (Burton et al., Appl. Catal. A 2011, 397, 153-162) we found that Pd on carbon black was very selective toward ethylene while Pd on alumina was not selective. For this work, we compared the performance of 0.5 wt % Pd on the uncoated oxide with the corresponding oxide precoated with 10 wt % carbon. The catalysts contained similarly sized (1-1.5 nm) Pd nanoparticles (see FIG. 35) prepared by direct alcohol reduction of Pd acetate at room temperature. A selective catalyst will convert all of the acetylene to ethylene without hydrogenating ethylene to ethane. However, as the acetylene conversion reaches 100%, all catalysts lose selectivity and start to show formation of ethane. The less-selective catalysts also hydrogenate some of the ethylene in the feed, thus leading to excess ethane. The amount of ethane formed is therefore a good measure of the selectivity of the catalyst, because selectivity at high acetylene conversion is desired. Ethane formation is presented as the ratio of moles of ethane in the effluent to moles of ethylene in the feed, which allows comparison with other feed compositions in the literature. The amount of ethane formed at the same acetylene conversion is higher on the silica and alumina supports and lower on the carbon-coated supports (FIG. 36), which are comparable in selectivity to Pd/Vulcan XC carbon black. These catalysts prevent overhydrogenation of ethylene, even at near 100% conversion of acetylene. Addition of promoters, such as Ag, will further improve selectivity; here we use this test reaction to show changes in the surface chemistry at the metal-oxide interface. It is clear that coating these oxides with carbon changes the surface chemistry, making the surface more hydrophobic (fewer surface hydroxyls by FTIR); the oxide-surface chemistry is reflected in the improved selectivity for the acetylene hydrogenation. A hydrothermally stable support is necessary for achieving stable reactivity for metal-catalyzed reactions in the aqueous phase.

In conclusion, our results show that carbon coatings can impart improved hydrothermal stability to silica and alumina, which are otherwise not stable for aqueous-phase reactions. Thin-film coatings of carbon change the surface chemistry of the oxides, making them less susceptible to hydrolytic attack at elevated temperatures. We demonstrated that high dispersions of metal particles can also be achieved on these supports, opening up the possibility of novel catalyst designs that could be applied to demanding aqueous-phase reactions. The carbon coatings provide a simple route to create supports for biomass conversion with properties that conventional carbon supports may lack, such as mesoporosity and mechanical strength.

### Example II

### TGA Analysis of Sucrose-Containing SBA-15

TGA of sucrose-containing SBA-15 was performed under N₂ flow from 25-800° C. (5 K min⁻¹) to show the % weight loss of sucrose with temperature during pyrolysis. The resulting TGA plot is shown in FIG. 37. The curve between the horizontal lines corresponds to the pyrolysis of sucrose (% weight loss below 100° C. is loss of water in the sample). The vertical line at 400° C. corresponds to the temperature used to pyrolyze the samples. The steep slope between 200-500° C. shows the % weight loss of sucrose during pyrolysis indicating that not all of the O and H atoms in sucrose are lost during the pyrolysis. At 400° C., the black dash-dot line in the plot corresponds to the loss of functional groups in carbon, whereas the red dash line corresponds to the remaining functional groups in carbon which was estimated to be 25%. The carbon being formed on SBA-15 therefore contains functional groups which are very important to achieve the desired properties in the carbon layer. Heating the sample to higher temperatures may cause these functional groups to be lost as the temperature is increased. Above 500° C., the curve begins to level off until at 800° C. there is little change in weight loss indicating that sucrose is converted to graphitic carbon with no functional groups present. The temperature at 800° C. is where we define complete pyrolysis, and is the pyrolysis temperature typically used to prepared ordered mesoporous carbon in the literature where a sacrificial templating technique is used to form the ordered carbon structures before removal of the sacrificial (usually silica) template.

### Example III

### Comparison of Pd Nanoparticle Stability after Hydrothermal Treatment when Supported on Carbon-Coated Silica or when Supported on Silica Followed by Coating with a Carbon Overlayer

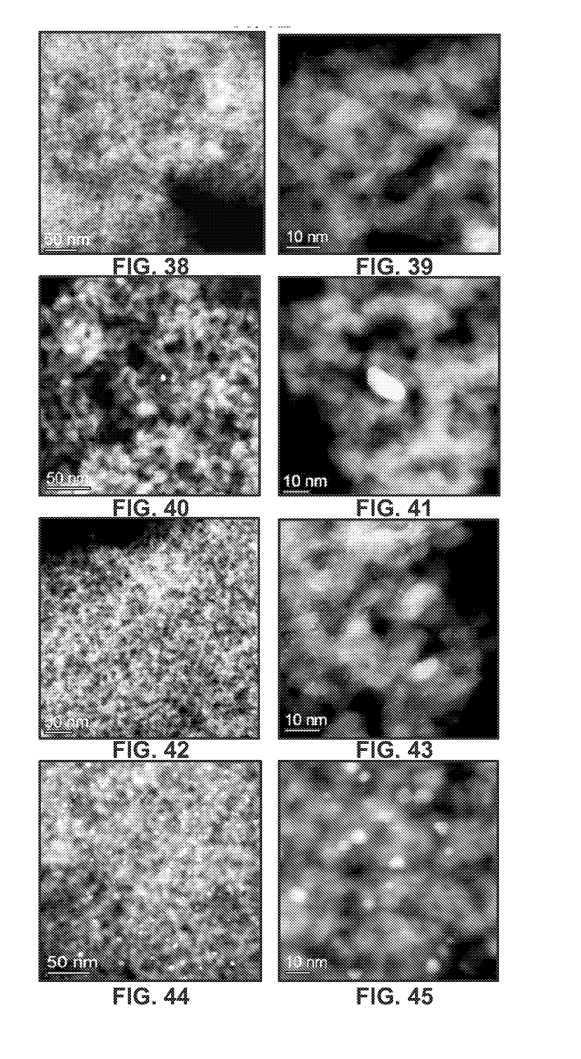

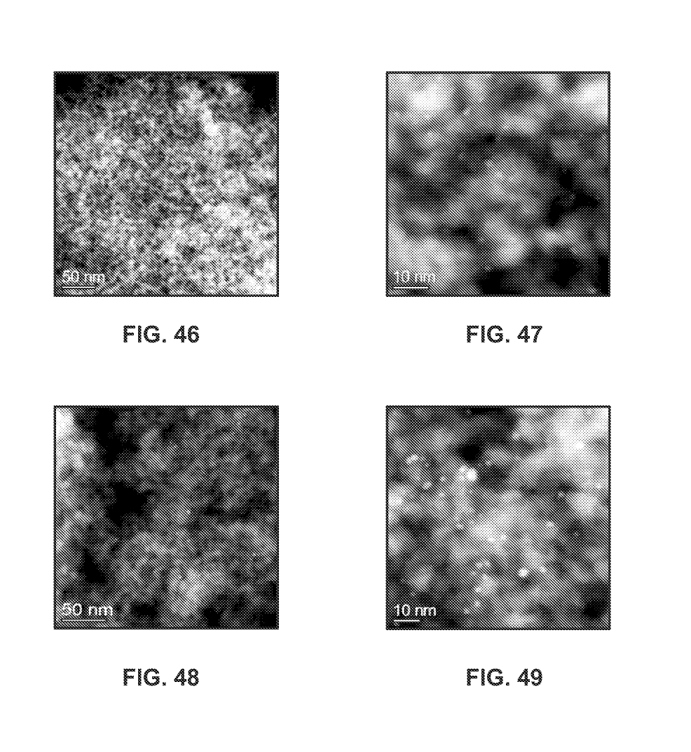

Pd nanoparticles (nominal loading 0.5 wt %) were deposited on silica supports (Pd/Si, FIGS. 38 and 39), carbon-coated silica supports (Pd/C—Si, FIGS. 42 and 43) and silica supports, after which both the supports and the Pd nanoparticles were coated with a carbon over-layer (C/Pd—Si, FIGS. 46 and 47) and then subjected to treatment in liquid water (473 K for 12 h) (FIGS. 40, 41, 44, 45, 48, and 49). Prior to treatment, all samples had a measured Pd loading of 0.4 wt % by EDS with 1-1.5 nm sized Pd nanoparticles (1-3 nm for the sample with the carbon over-layer) and a high Pd dispersion. Here we use the term dispersion as commonly used in the catalysis literature, as an indication of the % of surface atoms in the metal nanoparticles, A small metal nanoparticle, typically less than 1 nm has most of its atoms near the surface, hence we call a catalyst containing such nanoparticles to be highly dispersed. On the other hand, a nanoparticle of diameter 20 nm has approximately 5% of its atoms on the surface, and would be called poorly dispersed catalyst. After the high temperature water treatment (FIGS. 40 and 41), the Pd/Si sample had a measured Pd loading of <0.1 wt % by EDS due to leaching of Pd from the silica support, and the remaining Pd nanoparticles were measured in the 2-20 nm size range with low Pd dispersion due to Pd sintering. In contrast, after treatment, the Pd/C—Si sample had a measured Pd loading of 0.4 wt % by EDS with 2-5 nm sized Pd nanoparticles maintaining its high Pd dispersion (FIGS. 44 and 45), and the C/Pd—Si sample had a measured Pd loading of 0.4 wt % by EDS with 1.5-4 nm sized Pd nanoparticles and a high Pd dispersion (FIGS. 48 and 49), demonstrating that the thin carbon layer, whether placed over or under the Pd nanoparticles, serves to inhibit the sintering of Pd during high temperature liquid treatment. In parallel, the thin carbon layer inhibits the change in the structure of the silica support during high temperature liquid treatment since Pd sintering is often accompanied by (and could be caused by) a loss in the structural integrity of the silica support.

1. A method for depositing a thin carbon over-layer on a catalyst support material, the method comprising:
exposing the catalytic support material to an aqueous solution comprising between 5 and 30 wt % sucrose;
stirring the mixture until the product is dry; and
partially pyrolyzing the dried product.

2. The method of claim 1 wherein the catalyst support material is an oxide support.

3. The method of claim 1 wherein the catalyst support is SBA-15.

4. The method of claim 1 wherein the catalyst support is alumina.

5. The method of claim 1 further comprising depositing a catalytic material on the surface of the catalyst support before exposing the catalytic support material to the sucrose solution.

6. The method of claim 1, wherein the aqueous solution comprises between 5 and 25 wt % sucrose.

7. The method of claim 1, wherein the aqueous solution comprises between 7 and 13 wt % sucrose.

8. The method of claim 1, wherein the aqueous solution comprises between 15 and 30 wt % sucrose.

9. The method of claim 1 wherein the dried product is pyrolyzed at between 200 and 600° C.

10. The method of claim 1 wherein the dried product is pyrolyzed at between 300 and 500° C.

11. The method of claim 1 wherein the dried product is pyrolyzed at between 350 and 450° C.

12. The method of claim 9, wherein the dried product is pyrolyzed for between 1 and 8 hours.

13. The method of claim 9, wherein the dried product is pyrolyzed for between 1 and 4 hours.

14. The method of claim 1 comprising depositing a metal catalytic material on the thin carbon over-layer.

15. The method of claim 1 further comprising heat treating the metal catalytic material to remove the thin carbon over-layer.

16. The method of claim 15 further comprising applying a new thin carbon over-layer over the metal catalytic material by:
exposing the catalytic support material to an aqueous solution comprising between 5 and 30 wt % sucrose;
stirring the mixture until the produce is dry; and
partially pyrolyzing the dried product.

17. The method of claim 1 wherein the catalytic support material comprises a concave surface.

18. The method of claim 1 wherein the catalytic support material comprises a convex surface.

19. An oxide support material for catalysis comprising a thin carbon over-layer; and a metal catalyst deposited on the surface of the oxide support and over which the thin carbon over-layer has been applied; wherein the metal catalyst is partially covered by the thin carbon over-layer.

20-31. (canceled)

32. The oxide support material of claim 19, wherein the material is formed by:
exposing a catalytic support material to an aqueous solution comprising between 5 and 30 wt % sucrose;
stirring the mixture until the product is dry; and
partially pyrolyzing the dried product.
